(19) United States
(12) Patent Application Publication
(10) Pub. No.: US 2026/0154261 A1
(43) Pub. Date: Jun. 4, 2026

(54) SYSTEM, METHOD AND INTERFACE TO COMPOSE ARBITRARY QUERIES FOR BLOCKCHAIN DATA

(71) Applicant: Bullish Global, Grand Cayman (KY)

(72) Inventors: Timothy Aaron Banks, Grand Cayman (KY); Santhosh Nagappa Kumaraswamy, Grand Cayman (KY); Eric Zhiqiang Ma, Grand Cayman (KY); Mohammad Nauman, Grand Cayman (KY)

(21) Appl. No.: 19/177,358

(22) Filed: Apr. 11, 2025

Related U.S. Application Data
(60) Provisional application No. 63/633,196, filed on Apr. 12, 2024.

(51) Int. Cl. G06F 16/2452; G06F 16/23; G06F 16/248; G06F 16/25

(52) U.S. Cl. CPC G06F 16/2452; G06F 16/2379; G06F 16/248; G06F 16/258

(57) ABSTRACT

According to an aspect, there is provided a method to compose arbitrary queries against smart contract data from one or more nodes of a blockchain involving composing a query language statement for a query, generating a smart contract by a compiler based on macros defined in smart contract source code, handling the query using the smart contract, parsing the query language statement using a query library, and calling compiler generated library functions to perform the query. According to an aspect there is provided a system including one or more blockchain nodes providing a database storing smart contract data in a key-value format, and a processing system providing a dynamic and composable query interface to the blockchain nodes.

### CROSS REFERENCE

This application claims priority to and the benefit of U.S. Provisional Patent Application No. 63/633,196 entitled “SYSTEM, METHOD AND INTERFACE TO COMPOSE ARBITRARY QUERIES FOR BLOCKCHAIN DATA,” filed Apr. 12, 2024, the entire contents which is hereby incorporated by reference herein.

### FIELD

The improvements generally relate to the field of distributed computer systems, executable programs, debugging code, querying code, smart contract code, querying blockchain networks, blockchain infrastructure, and/or query language executed by smart contracts.

### INTRODUCTION

Querying blockchain data spread across decentralized and distributed nodes can be technically challenging. For example, it can be challenging to real-time query a blockchain from a client app (for example, java).

WebAssembly (Wasm) is an example instruction or code format for executable programs and is designed for performance but can be complex to work with, especially when integrating with other systems. A query language (QL) is a computer code to query information systems. Constructing a Wasm-QL query string can be complicated and incredibly verbose. Tools that can help with constructing these queries may not be sufficient to quickly and efficiently prepare the query string. Developers may get lost in the complex annotation which means that deserialization of the query string will fail (and may not provide an error message that is helpful).

The queries may be static in nature. Static queries can be stored, compiled and then executed. That is, the developer can only invoke queries that are declared in the query type at runtime. During troubleshooting, if a query that doesn't exist but might be helpful is required, a smart contract engineer would need to manually write the query code that may then need to be reviewed, merged into development, and pushed to the troubleshooting environment. To develop a new query may require rerunning, compiling, etc. All the above can take time and worker productivity that may be better spent elsewhere. The additional development comes at the cost of additional maintenance and places of error or failure.

Improvement in query implementation for blockchain smart contract data is desirable.

### SUMMARY

Dynamic blockchain query support in a language that most developers are familiar with is desirable. Described herein are methods and systems that utilize Structured Query Language (SQL) or other languages as the query language for execution by blockchain smart contracts. Embodiments described herein utilize an SQL parsing library to enable dynamic query creation and execution. The proposed solution overlays SQL syntax on top of blockchain data values (e.g. key-value (KV) tables), mapping SQL queries to the underlying data structures. The framework described herein can act as a bridge between the client app and the blockchain.

According to an aspect, there is provided a method to compose arbitrary queries for smart contract data stored across nodes of a blockchain, the method comprises: providing a dynamic and composable query interface to one or more devices with blockchain nodes, each blockchain node storing smart contract code and a blockchain database, wherein the smart contract code comprises metadata, a query library, and library functions; composing a query language statement for a query using input received at the query interface; generating a smart contract query call for handling the query using smart contract code stored on a blockchain node; parsing the query language statement for the query into elements of query syntax using the query library stored within the smart contract code; translating, by the smart contract code using the metadata, the elements of the query syntax by calling smart contract library functions to execute operations on the blockchain nodes to retrieve blockchain data from the blockchain database; and providing output of the query by the smart contract code by converting the retrieved blockchain data into a query language response format.

In some embodiments, the smart contract data is stored on a blockchain database in in a key value format, wherein a key value is serialized and stored for later retrieval.

In some embodiments, the metadata comprises a metadata table or reference table, wherein the metadata table or reference table registers data table information regarding at least one of: table structure, columns, and indices.

In some embodiments, the query library is one or more of Structured Query Language (SQL), Graph Query Language (GraphQL), and jq.

In some embodiments, the translating of the elements of the query syntax further comprises calling predefined functions for extended functionalities to execute additional operations on the blockchain nodes to retrieve the blockchain data from the blockchain database.

In some embodiments, composing the query language statement further comprises using a large language model trained to generate query language queries based on natural language input.

In other embodiments, there is provided a system to compose arbitrary queries against smart contract data, the system comprising: a processing system with one or more processors and one or more memories coupled with the one or more processors, the one or more memories having executable instructions stored thereon, the processing system executing the executable instructions configured to perform operations described herein.

In other embodiments, there is provided a non-transitory computer readable medium containing computer executable instructions that, when executed by a computer processor, cause the computer processor to perform processes described herein.

In other embodiments, there is provided a method to compose arbitrary queries against smart contract data from one or more nodes of a blockchain. The method involves composing a query language statement for a query, generating a smart contract by a compiler based on macros defined in smart contract source code, handling the query using the smart contract, parsing the query language statement using a query library, and calling compiler generated library functions to perform the query.

In some embodiments, the query language statement and the query library use SQL and/or GraphQL.

In some embodiments, the method further involves calling predefined functions for extended functionalities.

According to an aspect, there is provided a dynamic composable query interface for blockchain state stored in key value databases. A blockchain stores smart contract data in a database in a key value format wherein the value is serialized and stored for later retrieval.

According to an aspect, there is provided a composable method to query blockchain state.

According to an aspect there is provided a system. The system includes one or more devices for blockchain nodes providing a database storing smart contract data in a key value format, wherein a key value is serialized and stored for later retrieval, and a processing system (with one or more processors and one or more memories) providing a dynamic and composable query interface to the blockchain nodes, wherein the query interface composes a query and returns output results in response to the query, wherein the output results comprise smart contract data from the blockchain nodes.

In some embodiments, the query interface executes the query by parsing query syntax and mapping the query syntax to the key value format

In some embodiments, smart contract code includes a query library to provide a query library function.

In some embodiments, the query library has an in memory metadata table data structure to be initialized during run time for tracking the database storing the smart contract data.

In some embodiments, a compiler generates expanded code for processing the query. The expanded code during execution registers the database and index information into the metadata table, and a reference to a generated query handling function for the metadata table.

In some embodiments, the smart contract code specifies an action to call the query library function to evaluate the query.

In some embodiments, the query library function parses the query.

In some embodiments, a compiler compiles the smart contract code.

In some embodiments, the query interface calls the action to perform the query.

In some embodiments, the smart contract code calls the query library to parse the query and converts data from the database into the output results.

Many further features and combinations thereof concerning embodiments described herein will appear to those skilled in the art following a reading of the instant disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 shows a process diagram of an exemplary method of implementing a query layer to call the smart contract code, according to some embodiments.

FIG. 2 shows a diagram of the code generation and compilation process of method, according to some embodiments.

FIG. 3 shows a process diagram of an exemplary method for composing arbitrary queries against smart contract data from one or more nodes of a blockchain, according to some embodiments.

FIG. 4 shows a diagram of a smart contract running environment in a blockchain node, according to some embodiments.

FIG. 5 shows a process diagram of an exemplary method of processing a query, according to some embodiments.

FIG. 6 shows a block diagram of a system with a plurality of nodes for implementing the methods described herein, according to some embodiments.

FIG. 7 shows a block diagram of query interfaces residing on blockchain nodes for implementing the methods described herein, according to some embodiments.

FIG. 8 is a schematic diagram of an electronic device for querying smart contract code, according to some embodiments.

### DETAILED DESCRIPTION

Querying blockchain data spread across decentralized nodes or devices can be challenging due to the inherent complexity of aggregating and processing data in real-time. The decentralized nature of a blockchain infrastructure means that data is distributed across numerous nodes or devices, which can lead to performance bottlenecks and increased latency when attempting to query data from client applications. Each node maintains a portion/copy of the blockchain, and querying data requires coordination among these nodes. This decentralized structure complicates the process of finding specific information among large datasets, making real-time querying difficult and inefficient.

Blockchains may allow for querying on chain contract states in a number of ways. Some blockchains may be good at ingesting data but may not be good at providing efficient and performant ways to query blockchain state. Using EOSIO as an example, one approach to expose a query to the end user can be by an action on a nodeos-based contract that can execute process on a contract table and return a result set to the user. While this approach is technically usable, the queries can be expensive and this approach may affect nodeos' ability to produce blocks during execution. Another approach can be accomplished through a rodeos side chain, which maintains an entire copy of the running nodeos' state. Rodeos may be specifically built to be able to handle many concurrent reads against the chain, allowing for querying and data retrieval without impacting the main chain's performance. A contract can be written that can be installed onto the rodeos chain that exposes an action for submitting a GraphQL-like query (i.e., WasmQL).

WebAssembly (Wasm), while designed for performance, adds another layer of complexity, especially when constructing WasmQL query strings. These strings can be verbose and intricate, making it easy for developers to get lost in the complex annotations. This complexity can result in deserialization failures and unhelpful error messages, further complicating the querying process. Tools designed to assist with query construction may not be sufficient to quickly and efficiently prepare the query string, leading to potential errors and inefficiencies.

Additionally, WasmQL queries are static, meaning they can only invoke predefined queries at runtime. This limitation restricts flexibility and requires manual intervention from smart contract engineers to create new queries. The process of writing, reviewing, merging, and deploying new query code is time-consuming and can impact productivity. Static queries also introduce additional maintenance overhead and potential points of failure, as developers must ensure that each query is correctly constructed and integrated into the system.

A dynamic query support in a language that most developers are familiar with is useful. The solution proposed herein utilizes Structured Query Language (SQL) for querying blockchain data and aims to provide a more flexible, efficient, and developer-friendly querying mechanism. SQL allows for dynamic query creation, reducing the need for predefined queries and simplifying the query construction process. This approach enhances performance, reduces maintenance overhead, and improves the overall efficiency of querying blockchain data. By leveraging SQL's familiar syntax and dynamic capabilities, developers can more easily create and execute queries, leading to a more responsive and adaptable system.

In some blockchains, contract data can be stored in a database in a key-value (KV) format where the value can be serialized and stored for later retrieval. Data can be queried by the originating contract by constructing the key of interest and requesting the corresponding value and deserializing the data for further processing. This can present an onerous set of constraints on applications that attempt to query the blockchain state as they have to go through the contract interfaces to access the data. Furthermore, contracts may need to already have the queries pre-built and compiled and available on the blockchain for the caller function to access. By contrast, the framework described herein provides a dynamic and composable query interface to the blockchain state.

Described herein are systems, methods, and frameworks utilizing SQL or other languages as the query language for smart contracts. The framework described herein can act as a bridge between the client app and the blockchain for a composable way to query blockchain state in the query language of choice (including, for example, SQL, GraphQL, Natural Language Query, WASM-QL, jq, etc.). Also disclosed is the corresponding composable query interface accommodating the query above for blockchain state stored in KV databases.

According to an aspect, the query can be handled by the smart contract code residing on a blockchain node. The smart contract processing this query is generated by a compiler based on the macros defined in the smart contract source code. The SQL or query library parses the SQL query (or other query language statement) and call the compiler generated library functions to perform the queries. The query calls predefined functions for extended functionalities.

SQL syntax is highly reliable for composing query languages due to its structured and standardized format. To leverage SQL for querying blockchain data, a parsing layer is implemented to map SQL syntax to KV tables. This parsing layer acts as an intermediary, translating SQL queries into operations that interact with the KV tables. By using a Postgres flavor of SQL, the system benefits from less complex query strings and more dynamic queries, which require less additional code to be written and maintained. This approach simplifies the query construction process and enhances the flexibility of the system.

Dynamic queries are a significant advantage of using SQL. Unlike static queries, dynamic queries can be updated and modified on-the-fly, allowing developers to adapt to changing requirements and troubleshoot issues more efficiently. This capability reduces the need for predefined queries and minimizes the time and effort required for query development and maintenance. The parsing layer can be designed as a plug-and-play component, making it easy to integrate with existing systems and enabling seamless updates and modifications.

The framework described can also support other query languages, such as GraphQL or JSON (via jq), without deviating from its core principles. This versatility allows developers to choose the most suitable query language for their specific needs and ensures compatibility with various data formats and systems. Additionally, the proposed framework can translate between different query languages, facilitating interoperability and enabling the use of multiple query languages within the same system.

Furthermore, large language models (LLMs) can be integrated into the framework to enhance query language translation and processing. LLMs, such as GPT-3, have demonstrated strong abilities in natural language processing and translation tasks. By leveraging LLMs, the framework can improve the accuracy and efficiency of query translation, especially for complex or ambiguous queries. This integration can also enable advanced features, such as context-aware query generation and intelligent query optimization, further enhancing the system's performance and usability.

Embodiments of the framework incorporate LLMs by embedding them into the query processing pipeline. This involves interfacing with the LLMs through APIs or direct model embedding, allowing the framework to utilize the language model's capabilities for translation and processing tasks. LLMs analyze the context of incoming queries to generate more relevant translations. This is achieved by feeding the query and its surrounding context into the model, which then processes the information to produce context-aware translations.

The framework uses LLMs to optimize queries by identifying and correcting potential errors or ambiguities. This involves preprocessing the query to detect issues, passing it through the LLM for refinement, and post-processing the output to ensure it meets the desired accuracy and clarity.

Some advantages of the overall interface/framework described herein include that it can simplify the troubleshooting process (e.g., by reducing the number of steps, reducing the effort required, changing from a static framework to a dynamic one, etc.) and provide ease of composability and the ability to dynamically run the framework in the blockchain. In particular, the framework provided herein may query the blockchain itself rather than merely indexing.

The framework described herein offers an SQL-like interface, leveraging the familiarity developers have with SQL to query databases. This interface enables developers to generate SQL-like queries, making the querying process more intuitive and accessible. The interface can vary depending on the client application, allowing for flexibility in how queries are composed and executed. By providing an SQL-like interface, the framework simplifies the transition for developers who are accustomed to traditional database querying methods, enhancing usability and efficiency.

In some embodiments, the interface includes several key components to facilitate the querying process. First, there is provided a composable layer that interprets the query and aggregates the input, such as SQL. This layer acts as the initial point of interaction, where the query is composed and structured. Next, a parser processes the query, breaking it down into its constituent parts and ensuring it is correctly formatted.

Following the parser, a translator converts the input into a block query using the KV interface. This translation step is essential for mapping the SQL-like query to the underlying blockchain data structures, ensuring that the query can be executed successfully and efficiently. The translator bridges the gap between the high-level query language and the low-level data storage mechanisms, enabling seamless interaction with the blockchain.

Finally, the response layer handles the output of the query, composing and delivering the results back to the requesting application. This layer ensures that the data is exposed in a structured way, making it easy for the application to process and utilize the information. Depending on the requesting application, the response layer may translate the data into the appropriate format, such as JSON, ensuring compatibility and usability.

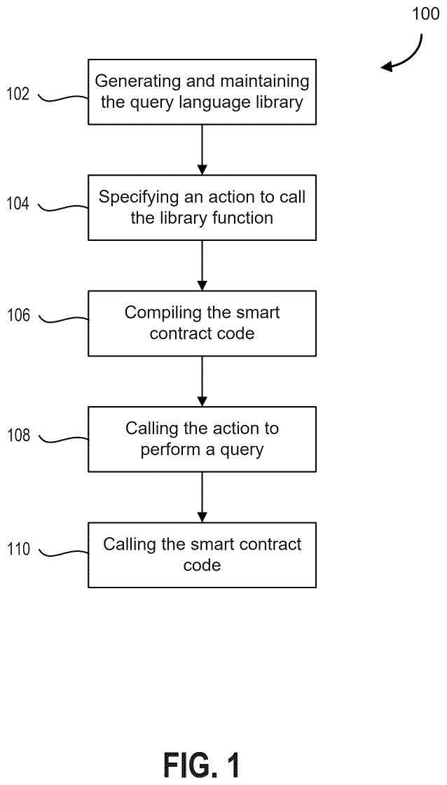

FIG. 1 shows a process diagram of an exemplary method 100 of implementing a query layer to call the smart contract code, according to some embodiments.

The method 100 may involve the steps of generating and maintaining the query language library (block 102), specifying an action to call the library function (block 104), compiling the smart code (block 106), calling the action to perform a query (block 108), and calling the smart contract code (block 110).

The following discussion makes reference to SQL as the query language, however, as described above, any suitable query language may be used. The references to SQL are for illustrative purposes only and do not narrow the scope of the concepts described herein.

At step 1 (block 102), a developer generates and maintains the SQL library in the smart contract code. The SQL library may have an in-memory metadata table data structure to be initialized during runtime for tracking the list of data tables. The smart contract code can include metadata, a query library, and library functions. Different examples of metadata, query libraries, and library functions are described herein. The code can then declare the table by calling:
DECLARE_TABLE(__table_name__, __table_type__, __columns__, __indices__)
   where: “table_name” is the name of the table that will be used in sql statements; “table_type” is the class or struct that defines the table; “columns” is a boost preprocessor sequence of tuples that holds the column name and column type pairing; and “indices” is a boost preprocess sequence of tuples where the first element is the index name and the second element is a sequence of columns. The developer can additionally specify “record_type”, which is the class or struct that defines the table schema.

The compiler expands the DECLARE_TABLE macro to generate the necessary code for processing SQL queries. During execution, the expanded code registers the table and index information into the metadata table and references the generated query handling function for the specified data table.

The CALL statement is utilized to execute stored procedures or macros within a query language environment. Stored procedures or macros are predefined library functions that can be invoked to perform specific operations on the database. A CALL statement can be executed using a stored_procedures structure. This structure includes a static method instance( ) to ensure a single instance of the structure is used throughout the application, promoting consistency and reducing overhead.

To integrate the stored procedures into the framework, the DECLARE_PROCEDURE macro is used. This macro registers the methods with the framework, specifying the contract account name, the structure holding the procedures, the method to invoke, and the parameters required. This registration process ensures that the stored procedures are accessible and executable within the query language environment.

At step 2 (block 104), the developer specifies an action sql to call the library function:
[[eosio::action]] std::vector<std::vector<eosio::anyvar>> sql(const std::string& query) const;

The action calls the library to evaluate the query string:
std::vector<std::vector<eosio::anyvar>> query_contract::sql(const std::string& query) const
{
   return sql_parser::sql::evaluate(query);
}

Subsequently, the library (or the smart contract code storing and maintaining the library) parses the SQL query. The library performs the following actions: analyzing the SQL query string by decomposing the query string into syntax elements following the SQL language standard; identifying the elements of the query syntax, including but not limited to the statement method (i.e., whether it's a SELECT or CALL), the table to query or the stored procedure to call, and filtering clause and parameters; and storing the parsed elements in memory as an abstract syntax tree (AST) to decide the execution method to be executed by the query handling engine and to provide the query execution parameters.

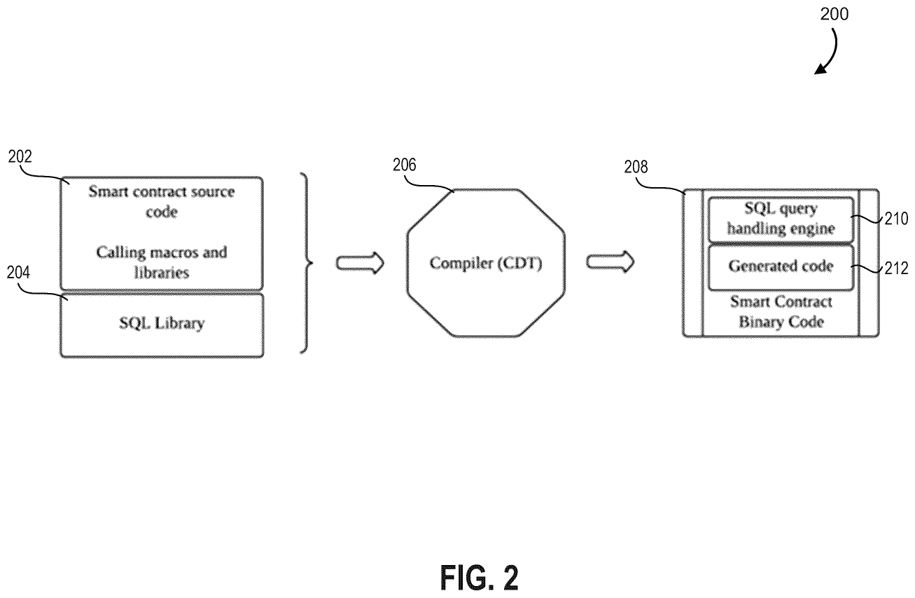

At step 3 (block 106) the compiler compiles the smart code in the source code format into binary format that can be deployed to the blockchain for execution. As noted, the smart contract code can include metadata, a query library, and library functions. Different examples of metadata, query libraries, and library functions are described herein. The step is further illustrated in FIG. 2.

In step 4 (block 108) users can call the sql action function of the smart contract by making a call to the blockchain node with the query string.

In step 5 (block 110) the smart contract code implementing the sql action is called by the blockchain node to perform SQL query with the query string as its input. The smart contract code calls the SQL library to parse the SQL query. Using the SQL query, the smart contract code locates data table metadata from the metadata table. Using the data table information (e.g., structure, columns, and indices) stored in the metadata table, the smart contract code calls the appropriate library functions to process the queries to the data table on the blockchain node. The smart contract code can additionally convert the data into a SQL response format or any other format matching that of the requesting application.

FIG. 2 shows a diagram of the code generation and compilation process of block 106, according to some embodiments. The smart contract code can include metadata, a query library, and library functions. Different examples of metadata, query libraries, and library functions are described herein. Smart contract code can be a self-executing piece of code with terms directly written into its programming. Smart contract code can be stored on the blockchain nodes to provide a decentralized and transparent system, and it automatically runs when certain predefined conditions are met or events occur. Query libraries can be collections of pre-written code or functions for retrieving and managing data from databases or other data sources. Query libraries can be designed to streamline complex operations by providing reusable components for querying, filtering, and processing data. Query library functions can be specific methods or operations provided by a query library that allow developers to interact with and manipulate data efficiently. These functions can simplify the process of writing and executing complex queries by abstracting low-level details. There can be different functions depending on the type of query library.

Smart contract source code 202 can include calling macros and libraries to access SQL library 204. This source code can be compiled using a compiler (e.g., a Contract Development Toolkit (CDT) compiler) 206 to output a smart contract in binary code 208 which includes an SQL query handling engine 210 and generated code 212.

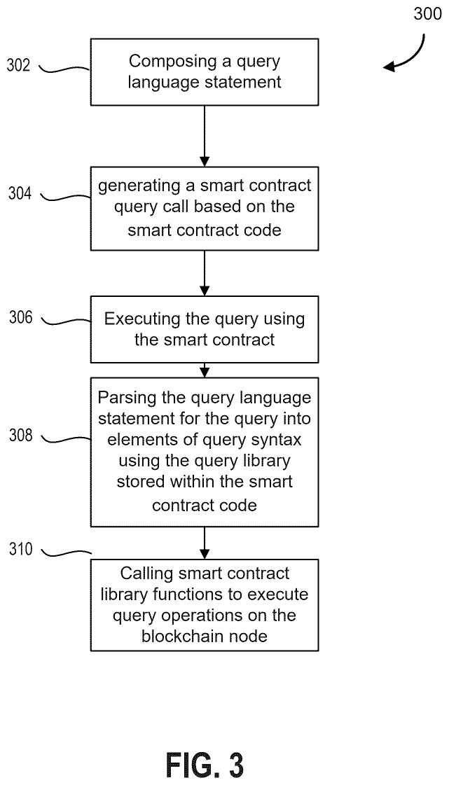

FIG. 3 shows a process diagram of an exemplary method 300 for composing arbitrary queries against smart contract data from one or more nodes of a blockchain, according to some embodiments.

According to an aspect, there is provided a method 300 to compose arbitrary queries against smart contract data from one or more nodes of a blockchain. A node can be a computer or device that runs blockchain software and participates in the network. Nodes can be for verifying transactions, maintaining the integrity of the blockchain data, and ensuring network security. A node can be classified as full nodes (maintaining a complete copy of the blockchain), light nodes (maintaining a partial copy), or other specialized types. A blockchain node can store smart contract code and a blockchain database. An example database can be a key-value database. A key-value table is a data structure that organizes information into pairs, where each key uniquely identifies a corresponding value.

The method 300 involves composing a query language statement for a query (block 302), generating a smart contract query call based on the interface defined in smart contract source code (block 304), handling the query using the smart contract (block 306), parsing the query language statement using a query library (block 308), and calling generated library functions to perform the query (block 310). For example, input can be received at the interface and the input can be used to compose the query language statement.

In a non-limiting example use case of method 300, the system queries all instruments from the instrument_table in contract custody.q using SQL:

At block 302, the process begins with constructing the SQL statement “SELECT*from instrument_table” to retrieve all records from the instrument_table. This step involves defining the query that will be used to access the data stored in the table, ensuring it adheres to the required syntax and structure for successful execution.

At block 304, the prepared SQL statement is used to invoke the smart contract custody.q with the syntax sql(“SELECT*from instrument_table”). The query call is then sent to the blockchain, initiating the interaction between the SQL query and the smart contract.

At block 306, the smart contract processes the query call according to its predefined rules and logic. At block 308, the SQL statement is parsed into an internal syntax tree data structure. Parsing breaks down the SQL statement into its components, organizing them into a hierarchical structure for efficient processing.

Finally, at block 310, the execution engine calls the smart contract library to execute the parsed query. The library contains predetermined library functions to interact with the blockchain and perform the query execution. The results are retrieved from the blockchain and returned in the SQL response format, completing the data retrieval process.

Accordingly, the method can involve composing a query language statement for a query using input received at the query interface, and generating a smart contract query call for handling the query using smart contract code stored on a blockchain node. The method further involves parsing the query language statement for the query into elements of query syntax using the query library stored within the smart contract code, and translating, by the smart contract code using the metadata, the elements of the query syntax by calling smart contract library functions to execute operations on the blockchain nodes to retrieve blockchain data from the blockchain database.

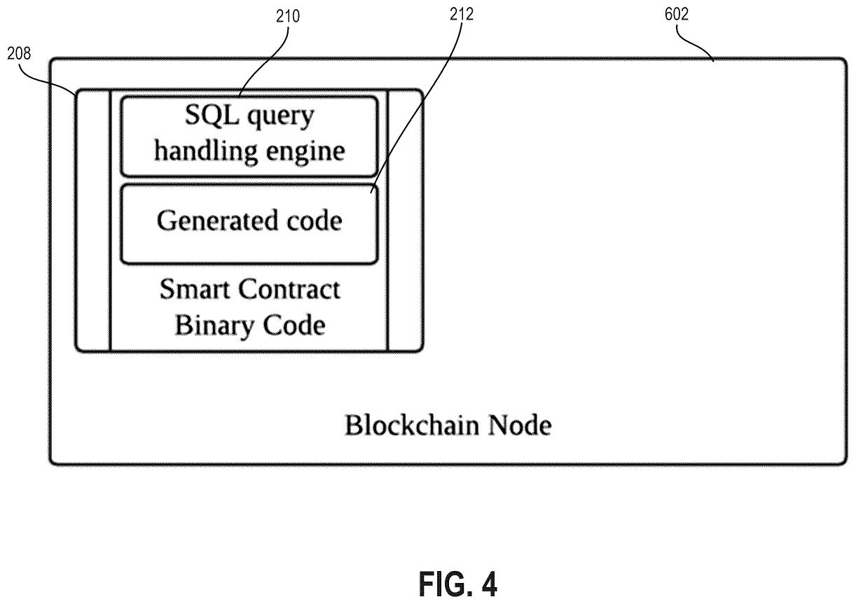

FIG. 4 shows a diagram of a smart contract running environment in a blockchain node 602, according to some embodiments.

SQL query handling engine 210 is responsible for parsing the SQL query, breaking it down into its constituent parts, and understanding the structure and intent of the query. The parsing process ensures that the query is correctly formatted and ready for further processing.

Generated code 212 includes functions to handle SQL queries. When a query is received, the smart contract 208 calls the SQL library to parse the query. This involves breaking down the SQL statement into its components and organizing them into a syntax tree data structure. The parsed query is then processed by the smart contract 208, which uses the metadata table to find the relevant data tables and execute the query.

During execution, the generated code 212 registers table and index information into an in-memory metadata object. The metadata tracks the list of data tables and their associated indices, enabling efficient query processing. The metadata table is initialized at runtime and updated as new tables and indices are declared.

In some embodiments, the smart contract 208 can be implemented and deployed to be stored in the blockchain database consisting of a set of blockchain nodes 602 with a smart contract running environment in each node. The blockchain database including the smart contract code is replicated to all the blockchain nodes 602. All blockchain nodes 602 have the same database and execute the same smart contract for the same smart contract action calls.

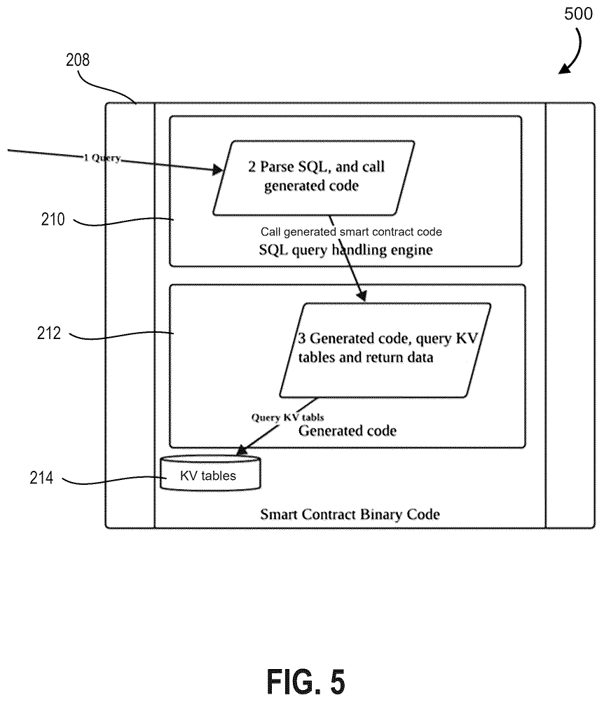

FIG. 5 shows a process diagram of an exemplary method 500 of processing a query, according to some embodiments. The method 500 provides a comprehensive approach to querying blockchain data using SQL. By leveraging the SQL query handling engine, metadata table, generated code, and SQL response format, the system ensures efficient and accurate data retrieval.

When a query is sent to the smart contract 208, it is passed to the SQL query handling engine 210. This engine is responsible for parsing the SQL query, breaking it down into its constituent parts, and understanding the structure and intent of the query. The parsing process ensures that the query is correctly formatted and ready for further processing.

Once the SQL query is parsed, the smart contract code utilizes the metadata table to locate the relevant data table metadata. The metadata table contains information about the structure, columns, and indices of the data tables, which is crucial for accurately processing the query. By referencing the metadata table, the smart contract code can identify the appropriate data table and understand how to interact with it.

After identifying the relevant data table, the smart contract code calls the generated code 212 to process the query. This generated code is responsible for executing the query against the blockchain data, which in some embodiments is in the form of KV tables 214. The generated code performs the necessary operations to retrieve the requested information. This step involves accessing the tables, applying the query conditions, and fetching the data that matches the query criteria.

Once the data is retrieved from the KV tables 214 or data stored in other formats, the smart contract code converts the data into the appropriate response format. In some embodiments, the smart contract code converts the data into SQL. This conversion ensures that the data is presented in a structured and standardized manner, making it easy for the client application to process and utilize the information. The SQL response format is familiar to developers and aligns with traditional database querying methods, enhancing usability and efficiency.

The following discussion illustrates the proposed solution in practical examples. As was the case above, the following discussion deals with SQL as the query language, however, as described above, any suitable query language may be used. The references to SQL are for illustrative purposes only and do not narrow the scope of the concepts described herein.

An example of an SQL based contract implementation is shown below. The SQL based implementation can also be implemented within the query contract. These macros may advantageously exist in the same source file as the SQL query action. The macros can register the tables with the SQL framework and expose the data for querying.
DECLARE_TABLE(
“instrument_table”,//The table name that will be used in queries.
instrument_table,//The declared type of the table.
((ticker, std::string))//The columns declared on the table.
((name, std::string))
((native_precision, uint8_t))
((custody_precision, uint8_t))
((trading_precision, uint8_t))
((type, instrument_type))
((status, status_type)),
((by_ticker, ((ticker, std::string))))//The indices declared on the table.
((by_name, ((name, std::string))((ticker, std::string))))
)
DECLARE_TABLE(
“network_table”,
network_table,
((id, std::string))
((name, std::string))
((min_block_height, uint64_t))
((required_confirmations, uint16_t))
((withdrawal_batch_size, uint16_t))
((addressing, addressing_type))
((fee, fee_type))
((type, network_type))
((status, status_type)),
((by_id, ((id, std::string))))
((by_name, ((name, std::string))((id, std::string))))
)
DECLARE_TABLE(
“coin_table”,
coin_table,
((id, std::string))
((instrument_id, std::string))
((network_id, std::string))
((status, status_type)),
((by_id, ((id, std::string))))
((by_instrument_id, ((instrument_id, std::string))((id, std::string))))
((by_network_id, ((network_id, std::string))((id, std::string))))
)
class [[eosio::contract(“coins.query”)]] query_contract:public eosio::contract
{
public:
using contract::contract;
[[eosio::action]] std::vector<std::vector<eosio::anyvar>> sql(const std::string& query) const;
};
namespace query {
EOSIO_ACTIONS(query_contract, b1x::coins_query_account, sql);
}
std::vector<std::vector<eosio::anyvar>> query_contract::sql(const std::string& query) const
{
return sql_parser::sql::evaluate(query);
}

To reimplement the same queries from above using SQL may be as follows:
cleos push action coins.q sql ‘SELECT*FROM coin_table WHERE id=\‘BTC@BTC\’’
cleos push action coins.q sql ‘SELECT*FROM network_table WHERE id=\‘BTC\’’
cleos push action coins.q sql ‘SELECT*FROM instrument_table WHERE ticker=\‘BTC\’’

In the above example, the provided code begins by declaring three tables: instrument_table, network_table, and coin_table. Each table is defined with specific columns and indices, which are essential for organizing and accessing the data efficiently. The DECLARE_TABLE macro is used to generate the necessary code for processing SQL queries related to these tables.

Specifically, the instrument_table is declared with columns such as ticker, name, native_precision, custody_precision, trading_precision, type, and status. These columns represent various attributes of financial instruments. Additionally, indices like by_ticker and by_name are defined to facilitate quick lookups based on the ticker and name of the instruments. The macro DECLARE_TABLE expands to register the table and index information into the metadata table, ensuring that the table structure is recognized by the SQL framework.

Similarly, the network_table is declared with columns including id, name, min_block_height, required_confirmations, withdrawal_batch_size, addressing, fee, type, and status. These columns capture details about different networks. Indices such as by_id and by_name are specified to enable efficient querying based on the network ID and name. The DECLARE_TABLE macro processes these declarations, registering the table and indices in the metadata table and linking them to the generated query handling functions.

The DECLARE_TABLE macro plays a pivotal role in the example table declaration process. It generates the code required to register the table and index information into the metadata table. This registration is crucial for the SQL framework to recognize the table structure and link it to the appropriate query handling functions. During execution, the expanded code ensures that the table and index information is correctly registered, enabling dynamic querying of blockchain data.

The coin_table is declared with columns like id, instrument_id, network_id, and status. These columns describe various attributes of coins. Indices such as by_id, by_instrument_id, and by_network_id are defined to allow quick access based on the coin ID, instrument ID, and network ID. The DECLARE_TABLE macro expands to include these details in the metadata table, ensuring that the SQL framework can efficiently process queries related to the coin table.

In some embodiments, there may be no static queries defined in the smart contract code when the smart contract is developed, allowing queries to be dynamic. Dynamic queries are provided by the smart contract action call parameters as query strings and are not pre-defined during smart contract development time. The query string may be well understood and concise. However, static queries may still be implemented and defined, for example, for stored procedures, which can be any instance method defined on any type as long as there is a singleton declared on that type.

The SQL parsing library may support a number of statements. For example, the SQL parsing library may support both the SELECT and CALL statements.

The CALL statement can be used for executing a stored procedure. Functions may be declared that can be invoked through a query language. The following is an example CALL statement:

struct stored_procedures
{
static auto& instance( )
{
static auto instance_ = stored_procedures{ };
return instance_;
}
template <typename Functor>
auto sum(const std::string& coin_code, Functor&& f)
{
auto code = bullish::coin_code{coin_code};
auto sum = coins::accessor::bullish_coin(“0 ” + coin_code);
for (auto it = std::begin(tx_table::instance( ).by_id); it !=
std::end(tx_table::instance( ).by_id); ++it) {
auto value = it.value( );
if (value.amount.symbol_code( ) == code && f(value)) {
sum += value.amount;
}
}
auto result = sql_parser::details::cursor_type{ };
result.emplace_back( );
result.back( ).emplace_back(sum);
return result;
}
auto sum_for_coin(const std::string& coin_code)
{
return sum(coin_code, [ ](const auto& record){ return true; });
}
auto sum_for_customer(const std::string& coin_code, uint64_t user_id)
{
return sum(coin_code, [&](const auto& record){ return record.user_id == user_id; });
}
auto sum_for_status(const std::string& coin_code, uint64_t status)
{
return sum(coin_code, [&](const auto& record){ return record.status == status; });
}
};
// Register the “stored procedures” with the framework
DECLARE_PROCEDURE(
b1x::custody_account.to_string( ), // The contract account name
stored_procedures, // The declared type that holds the “stored procedures”
sum_for_coin, // The instance method to invoke on the type.
((coin_code, std::string))) // The parameters of the “stored procedure”.
DECLARE_PROCEDURE(
b1x::custody_account.to_string( ),
stored_procedures,
sum_for_customer,
((coin_code, std::string))((user_id, uint64_t)))
DECLARE_PROCEDURE(
b1x::custody_account.to_string( ),
stored_procedures,
sum_for_status,
((coin_code, std::string))((status, uint64_t)))

We can then push actions similar to the following:
cleos push action coins.q sql ‘CALL stored_procedures.sum_for_coin(coin_code =>\‘BTC@BTC\’);’
cleos push action coins.q sql ‘CALL stored_procedures.sum_for_coin(coin_code =>\‘ETH@ETH\’);’
cleos push action coins.q sql ‘CALL stored_procedures.sum_for_coin(coin_code =>\‘USDC@ETH\’);’

The example above begins by defining a stored_procedures struct, which includes several methods for calculating sums based on different criteria. The instance method ensures that there is a single instance of the stored_procedures struct, following the singleton pattern. This is crucial for maintaining a consistent state across multiple queries.

The core method within the stored_procedures struct is sum, which takes a coin_code and a functor f as parameters. This method initializes a coin_code object and starts with a sum of zero for the specified coin. It then iterates over the transaction table (tx_table) to accumulate the sum of amounts that match the given coin_code and satisfy the condition defined by the functor f. The result is stored in a cursor type and returned as a vector of vectors, which is suitable for SQL query responses.

Three specific sum methods are defined: sum_for_coin, sum_for_customer, and sum_for_status. Each of these methods calls the sum method with different conditions:
sum_for_coin calculates the total sum for a given coin code without any additional filtering.
sum_for_customer calculates the sum for a given coin code, but only includes transactions associated with a specific user ID.
sum_for_status calculates the sum for a given coin code, but only includes transactions with a specific status.

The example then registers these stored procedures using the DECLARE_PROCEDURE macro. This macro links the stored procedures to the contract account and specifies the parameters required for each procedure. This registration process is essential for making the stored procedures accessible through SQL queries.

Finally, the code provides examples of how to execute the stored procedures using SQL queries. The cleos push action commands demonstrate how to call the sum_for_coin procedure for different coin codes (BTC@BTC, ETH@ETH, USDC@ETH). These commands allow the user to dynamically query blockchain data to calculate sums based on various criteria.

The framework described herein can additionally support a subset of clauses that are available for a SELECT statement. The DECLARE_TABLE macro can register a table for use in a SELECT statement. The following example provides the full subset that can be supported (the following example specifically uses, but is not limited to the Postgres flavor of SQL):
SELECT column1, column2, . . . , columnN FROM table WHERE column1==“foobar” LIMIT 10 OFFSET 10

The LIMIT and OFFSET clauses may be needed to continue to allow pagination support where LIMIT sets the maximum number of records to be returned by the query and OFFSET sets the starting point to return the records in the queried results as if it is queried without the OFFSET clause. As an example, “LIMIT 10 OFFSET 20” indicates that the query results shall be 10 records from the 21st records from the initial query results.

Along with the example clauses, a WHERE clause can also be introduced to help handle the integration of KV table indices into the SQL framework. A major hurdle in overlaying an SQL syntax on top of the KV tables can be picking the “best” index to use when iterating over the table to produce the resulting cursor. One approach may infer the best index from the set of conditions found within the WHERE clause (though this may be a complicated problem to solve). Another approach may introduce a RANGE clause to allow the query author to explicitly choose which index to use for their query (if the RANGE clause is missing, the SQL framework may default to, for example, the primary index on the table). The RANGE clause can immediately follow the WHERE clause. For an example:
SELECT column1, column2, . . . , columnN FROM table WHERE column1==“foobar” RANGE [columnn1, column2]>=[“foo”, “bar”] AND [column1, column2] <[“fooo”, “barr”] LIMIT 10 OFFSET 10

Tuples can be used within the RANGE clause to allow for specifying as many of the columns within the index as needed. When the SQL parser encounters this clause, it locates the first index that can be constructed with the columns. This can allow the query author to closely bound (or exclude large portions of the KV table from) their query instead of always starting from the beginning and going to the end of the KV table.

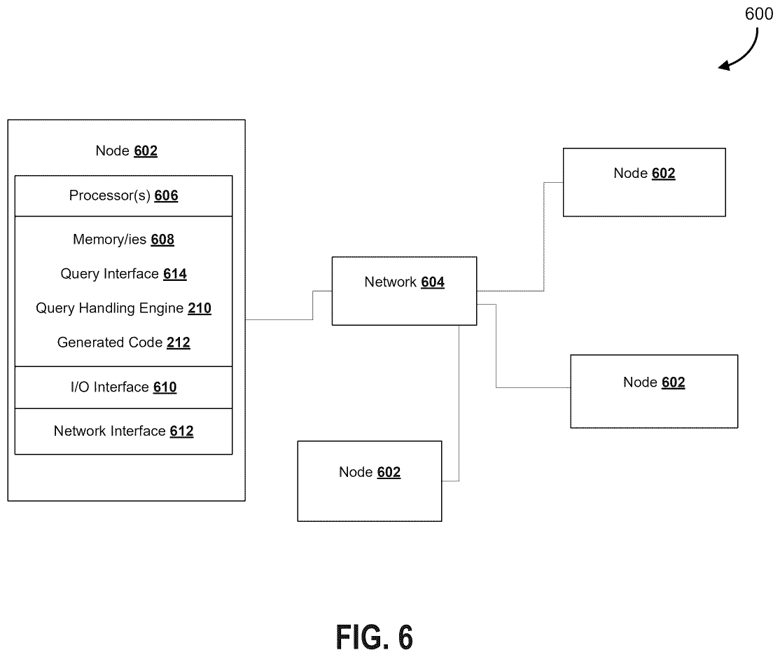

FIG. 6 shows a block diagram of a system 600 with a plurality of nodes 602 for implementing the methods described herein, according to some embodiments.

An example node 602 has a memory 608 storing a query interface 614 with a handling engine 210 and generated code 212 corresponding to smart contract code 500. The node 602 can receive a query and parse the query using the query handing engine 210. This can send call generated code to the generated code 212. The generated code 212 can query the KV table and return data. The data returned may be rendered into a format usable by the user (e.g., based on the query language used initially).

The system 600 can include at least one processor 606, memory 608, at least one I/O interface 610, at least one network interface 612, and a query interface 614. The I/O interface 610 can enable system 600 to interconnect with one or more input devices, such as a keyboard, mouse, camera, touch screen and a microphone, or with one or more output devices such as a display screen and a speaker. The network interface 612 can enable system 600 to communicate with other components, to exchange data with other components, to access and connect to network resources, to serve applications, and perform other computing applications by connecting to a network 604 (or multiple networks, or a combination of different networks) capable of carrying data. The hardware components of system 600 may be connected in various ways including directly coupled, indirectly coupled via a network, and distributed over a wide geographic area and connected via a network (which may be referred to as “cloud computing”). For example, and without limitation, the system 600 may be a server, network appliance, embedded device, computer expansion module, or other computing device capable of being configured to carry out the methods described herein. Memory 608 can be distributed storage devices for a blockchain infrastructure or web applications. System 600 has distributed memory of nodes 602 to provide blockchain infrastructure. Different variations of node 602 are shown in system 600.

The system 600 can connect to one or more electronic devices to exchange data. An electronic device can have memory storing instructions for applications and one or more processors that execute the instructions and query interface 614.

According to an aspect there is provided a system 600. The system 600 includes one or more blockchain nodes 602 providing a database storing smart contract data in a key value format, wherein a key value is serialized and stored for later retrieval, and a processing system 606 providing a dynamic and composable query interface 614 to the blockchain nodes 602, wherein the query interface 614 composes a query and returns output results in response to the query, wherein the output results comprise smart contract data from the blockchain nodes 602.

In some embodiments, the query interface 614 executes the query by parsing query syntax and mapping the query syntax to the key value format (e.g., with query handling engine 210).

In some embodiments, smart contract code 208 includes a query library 204 to provide a query library function.

In some embodiments, the query library has an in memory metadata table data structure to be initialized during run time for tracking the database storing the smart contract data. The metadata table is an example of metadata of the smart contract code.

In some embodiments, a compiler 206 generates expanded code for processing the query. The expanded code during execution registers the database and index information into the metadata table, and a reference to a generated query handling function for the metadata table.

In some embodiments, the smart contract code 208 specifies an action to call the query library function to evaluate the query.

In some embodiments, the query library function parses the query.

In some embodiments, a compiler 206 compiles the smart contract code 208.

In some embodiments, the query interface 614 calls the action to perform the query.

In some embodiments, the smart contract code 208 calls the query library to parse the query and converts data from the database into the output results.

According to an aspect, there is provided a dynamic composable query interface 614 for blockchain state stored in key value databases. A blockchain stores smart contract data in a database in a key value format wherein the value is serialized and stored for later retrieval.

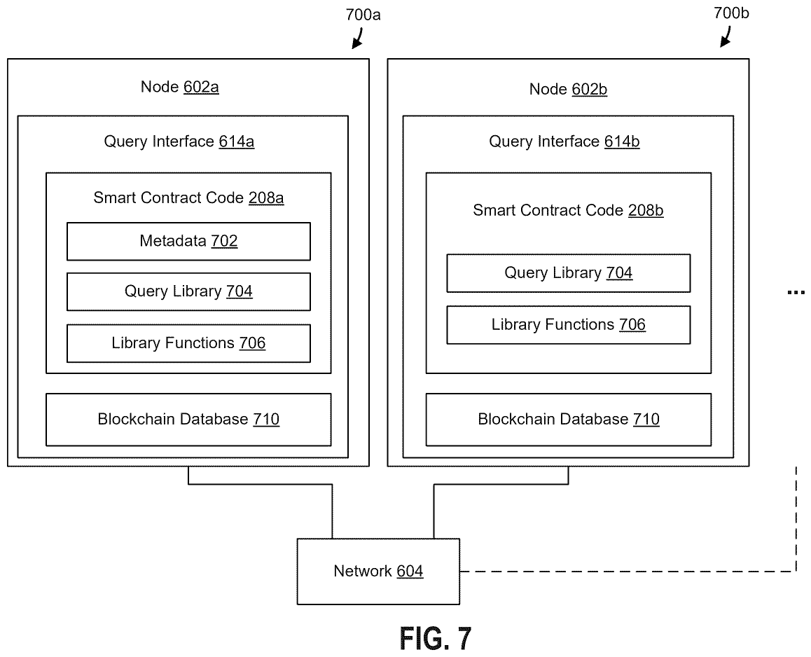

FIG. 7 shows a block diagram of query interfaces residing on blockchain nodes for implementing the methods described herein, according to some embodiments. As illustrated by example system 700a, query interface 614a residing on a blockchain node 602a stores smart contract code 208a and a blockchain database 710, wherein the smart contract code 208a comprises metadata 702, a query library 704, and library functions 706. Example system 700b illustrates a variation of a query interface on blockchain node 602b, wherein query interface 614b stores and executes smart contract code 208b containing query library 704 and library functions 706. Additional variations in configuration of query interface 614 are also possible but are not illustrated in FIG. 7.

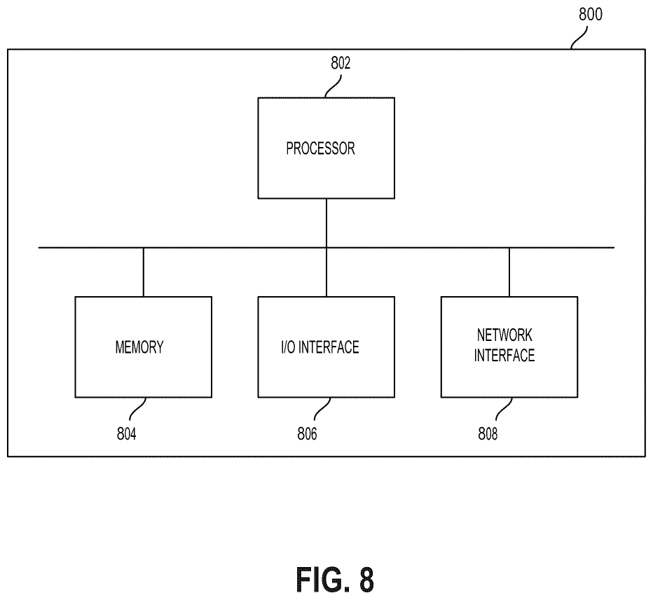

FIG. 8 is a schematic diagram of an electronic device 800 for querying smart contract code, according to some embodiments.

As depicted, electronic device 800 includes at least one processor 802, memory 804, at least one I/O interface 806, and at least one network interface 808.

Each processor 802 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 804 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 806 can enable electronic device 800 to interconnect with one or more input devices, such as a keyboard, mouse, camera, touch screen and a microphone, or with one or more output devices such as a display screen and a speaker.

Each network interface 808 can enable electronic device 800 to communicate with other components, to exchange data with other components, to access and connect to network resources, to serve applications, and perform other computing applications by connecting to a network (or multiple networks) capable of carrying data.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references were made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

One should appreciate that the systems and methods described herein may provide better memory usage, improved processing, improved bandwidth usage.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps

As can be understood, the examples described above and illustrated are intended to be exemplary only.

What is claimed is:

1. A method to compose arbitrary queries for smart contract data stored across nodes of a blockchain, the method comprising:
providing a dynamic and composable query interface to one or more devices with blockchain nodes, each blockchain node storing smart contract code and a blockchain database, wherein the smart contract code comprises metadata, a query library, and library functions;
composing a query language statement for a query using input received at the query interface;
generating a smart contract query call for handling the query using smart contract code stored on a blockchain node;
parsing the query language statement for the query into elements of query syntax using the query library stored within the smart contract code;
translating, by the smart contract code using the metadata, the elements of the query syntax by calling smart contract library functions to execute operations on the blockchain nodes to retrieve blockchain data from the blockchain database; and
providing output of the query by the smart contract code by converting the retrieved blockchain data into a query language response format.

2. The method of claim 1 wherein the smart contract data is stored on the blockchain database in a key value format, wherein a key value is serialized and stored for later retrieval.

3. The method of claim 1 wherein the metadata comprises a metadata table or reference table, wherein the metadata table or reference table registers data table information regarding at least one of: table structure, columns, and indices.

4. The method of claim 1 wherein the query library accommodates query language in the form of one or more of Structured Query Language (SQL), Graph Query Language (GraphQL), and jq.

5. The method of claim 1 wherein translating further comprises calling predefined functions for extended functionalities to execute additional operations on the blockchain nodes to retrieve the blockchain data from the blockchain database.

6. The method of claim 1 wherein composing further comprises generating, using a large language model trained to generate query language queries based on natural language input.

7. The method of claim 1 further comprising translating output of the query into a format of a requesting application.

8. A system to compose arbitrary queries against smart contract data, the system comprising: a processing system with one or more processors and one or more memories coupled with the one or more processors, the one or more memories having executable instructions stored thereon, the processing system executing the executable instructions configured to:
provide a dynamic composable query interface to one or more devices with blockchain nodes, each blockchain node storing smart contract code and a blockchain database, wherein the smart contract code comprises metadata, a query library, and library functions;
compose a query language statement for a query using input received at the query interface;
generate a smart contract query call for handling the query using smart contract code stored on a blockchain node;
parse the query language statement for the query into elements of query syntax using the query library stored within the smart contract code;
translate, by the smart contract code using the metadata, the elements of the query syntax by calling smart contract library functions to execute operations on the blockchain nodes to retrieve blockchain data from the blockchain database;
provide output of the query by the smart contract code by converting the retrieved blockchain data into a query language response format.

9. The system of claim 8 further comprising the one or more devices with the blockchain nodes providing the blockchain database, wherein the smart contract data is stored on the blockchain database in a key value format, wherein a key value is serialized and stored for later retrieval.

10. The system of claim 8 wherein the metadata comprises a metadata table or reference table, wherein the metadata table or reference table registers data table information regarding at least one of: table structure, columns, and indices.

11. The system of claim 8 wherein the query library accommodates query language in the form of one or more of Structured Query Language (SQL), Graph Query Language (GraphQL), and jq.

12. The system of claim 8 wherein translating further comprises calling predefined functions for extended functionalities to execute additional operations on the blockchain nodes to retrieve the blockchain data from the blockchain database.

13. The system of claim 8 wherein composing further comprises generating, using a large language model trained to generate query language queries based on natural language input.

14. The system of claim 8 further comprising translating output of the query into a format of a requesting application.

15. The system of claim 9 wherein the query interface executes the query language statement by parsing query syntax and mapping the query syntax to the key value format.

16. The system of claim 8 wherein the query library has an in memory metadata table data structure to be initialized during run time for tracking the database storing the smart contract data.

17. The system of claim 9 wherein a compiler generates expanded code for processing the query, wherein the expanded code during execution registers the database and index information into a metadata table, and a reference to a generated query handling function for the metadata table.

18. The system of claim 8 wherein the smart contract code specifies an action to call the query library function to evaluate the query, wherein the query library function parses the query, wherein a compiler compiles the smart contract code, and wherein the query interface calls the action to perform the query.

19. The system of claim 14 wherein the smart contract code calls the query library to parse the query and converts data from the database into the output results.

20. A non-transitory computer readable medium containing computer executable instructions that, when executed by a computer processor, cause the computer processor to perform steps of a method to compose arbitrary queries for smart contract data stored across nodes of a blockchain, the method comprising:
composing a query language statement using a dynamic and composable query interface to one or more devices with blockchain nodes, each blockchain node storing smart contract code and a blockchain database, wherein the smart contract code comprises metadata, a query library, and library functions;
generating a smart contract query call for handling the query using smart contract code stored on a blockchain node;
parsing the query language statement for the query into elements of query syntax using the query library stored within the smart contract code;
translating, by the smart contract code using the metadata, the elements of the query syntax by calling smart contract library functions to execute operations on the blockchain nodes to retrieve blockchain data from the blockchain database; and
providing output of the query by the smart contract code by converting the retrieved blockchain data into a query language response format.
